(19) United States
(12) Patent Application Publication
(10) Pub. No.: US 2026/0261322 A1
(43) Pub. Date: Sep. 3, 2026

(54) METHOD AND DEVICE FOR BEAM MANAGEMENT IN SIDELINK COMMUNICATION

(71) Applicants: HYUNDAI MOTOR COMPANY, Seoul (KR); KIA CORPORATION, Seoul (KR); Gachon University Industry-Academic Corporation Foundation, Seongnam-si, Gyeonggi-do (KR)

(72) Inventors: Ui Hyun Hong, Hwaseong-si, Gyeonggi-do (KR); Hyuk Min Son, Seoul (KR)

(73) Assignees: HYUNDAI MOTOR COMPANY, Seoul (KR); KIA CORPORATION, Seoul (KR); Gachon University Industry-Academic Cooperation Foundation, Seongnam-si, Gyeonggi-do (KR)

(21) Appl. No.: 18/881,723

(22) PCT Filed: Sep. 6, 2023
(86) PCT No.: PCT/KR2023/013336

§ 371 Date: Jan. 6, 2025

(30) Foreign Application Priority Data
Sep. 6, 2022 (KR) 10-2022-0112872

(51) Int. Cl. H04B 7/06

(52) U.S. Cl. CPC H04B 7/06952; H04B 7/0626; H04B 7/0632; H04B 7/0639

(57) ABSTRACT

The present disclosure provides a method and a device for managing a beam in sidelink communication. The method according to one embodiment of the present disclosure relates to a method for a first UE, and may comprise the steps of: transmitting a CSI request for requesting a second UE to report CSI about a transmission beam; transmitting a pre-configured signal to the second UE through the transmission beam; and receiving the CSI report for the transmission beam from the second UE.

### TECHNICAL FIELD

The present disclosure relates to a sidelink communication technique, and more particularly, to a sidelink beam management technique.

### BACKGROUND ART

A communication network (e.g. 5G communication network or 6G communication network) is being developed to provide enhanced communication services compared to the existing communication networks (e.g. long term evolution (LTE), LTE-Advanced (LTE-A), etc.). The 5G communication network (e.g. New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, there are currently no standardized techniques developed for beam management in a sidelink (SL) FR2 licensed band. Therefore, for evolution of NR SL in Rel. 18, it is required to develop solutions for beam management in the SL FR2 licensed band.

### DISCLOSURE

### Technical Problem

The present disclosure is directed to providing a method and an apparatus for beam management in sidelink communication.

### Technical Solution

A method of a first user equipment (UE), according to an exemplary embodiment of the present disclosure, may comprise: transmitting, to a second UE, a channel state information (CSI) request requesting to report CSI for transmission beam(s); transmitting a pre-configured signal to the second UE through the transmission beam(s); and receiving, from the second UE, a CSI report for the transmission beam(s), wherein the CSI request may include information on a type of the pre-configured signal for beam management, and the information on the type of the pre-configured signal may indicate at least one of a CSI-reference signal (CSI-RS), a synchronization signal (SS), or a demodulation reference signal (DMRS).

When the CSI request indicates the CSI-RS and the DMRS together, and the pre-configured signal is transmitted through two or more transmission beams, the CSI report may be measurement information using the DMRS for a first transmission beam being used for sidelink communication.

The DMRS may be transmitted through the first transmission beam, and the CSI-RS may be transmitted through all of the two or more transmission beams.

When the CSI request indicates the SS and the CSI-RS together, and the pre-configured signal is transmitted through two or more transmission beams, the CSI report may be measurement information using the SS for a first transmission beam being used for sidelink communication.

The SS may be transmitted through the first transmission beam, and the CSI-RS may be transmitted on all of the two or more transmission beams.

The CSI request may be transmitted by first-stage sidelink control information (SCI), and the first-stage SCI may include at least one of information indicating absence of second-stage SCI, resource configuration information of the pre-configured signal, information indicating the CSI request, information on a CSI reporting type, information on a number of CSI reports, resource information for a container to be used for CSI reporting, information on a latency bound for CSI reporting, or timing information for CSI reporting.

The information on the CSI reporting type may indicate at least one of a Reference Signal Received Power (RSRP) for a beam, beam quality information (BQI) indicating a Layer 1-RSRP (L1-RSRP), a beam index (BI) indicating CSI for management purposes, channel quality information (CQI), or rank indicator (RI).

A method of a second user equipment (UE), according to an exemplary embodiment of the present disclosure, may comprise: receiving, from a first UE, a channel state information CSI request requesting to report CSI for transmission beam(s) of the first UE; receiving a pre-configured signal through the transmission beam(s) of the first UE based on the CSI request; measuring the received pre-configured signal to generate a CSI report for the transmission beam(s); and transmitting the CSI report to the first UE, wherein the CSI request may include information on a type of the pre-configured signal for beam management, and the information on the type of the pre-configured signal may indicate at least one of a CSI-reference signal (CSI-RS), a synchronization signal (SS), or a demodulation reference signal (DMRS).

When the CSI request indicates the CSI-RS and the DMRS together, and the pre-configured signal may be transmitted through two or more transmission beams, the CSI report may be generated based on measurement of the DMRS received through a first transmission beam being used for sidelink communication.

The method may further comprise: performing refinement on the transmission beam(s) by using the CSI-RS included in a transmission beam other than the first transmission beam.

When the CSI request indicates the SS and the CSI-RS together, and the pre-configured signal may be transmitted through two or more transmission beams, the CSI report may be generated based on measurement of the SS received through a first transmission beam being used for sidelink communication.

The method may further comprise: performing refinement on the transmission beam(s) by using the CSI-RS included in a transmission beam other than the first transmission beam.

The CSI request may be transmitted by first-stage sidelink control information, and the first-stage SCI may include at least one of information indicating absence of second-stage SCI, resource configuration information of the pre-configured signal, information indicating the CSI request, information on a CSI reporting type, information on a number of CSI reports, resource information for a container to be used for CSI reporting, information on a latency bound for CSI reporting, or timing information for CSI reporting.

The information on the CSI reporting type may indicate at least one of a Reference Signal Received Power (RSRP) for a beam, beam quality information (BQI) indicating a Layer 1-RSRP (L1-RSRP), a beam index (BI) indicating CSI for management purposes, channel quality information (CQI), or rank indicator (RI).

A first user equipment (UE), according to an exemplary embodiment of the present disclosure, may comprise at least one processor, wherein the at least one processor causes the first UE to perform: transmitting, to a second UE, a channel state information (CSI) request requesting to report CSI for transmission beam(s); transmitting a pre-configured signal to the second UE through the transmission beam(s); and receiving, from the second UE, a CSI report for the transmission beam(s), wherein the CSI request may include information on a type of the pre-configured signal for beam management, and the information on the type of the pre-configured signal may indicate at least one of a CSI-reference signal (CSI-RS), a synchronization signal (SS), or a demodulation reference signal (DMRS).

When the CSI request indicates the CSI-RS and the DMRS together, and the pre-configured signal is transmitted through two or more transmission beams, the CSI report may be measurement information using the DMRS for a first transmission beam being used for sidelink communication.

The DMRS may be transmitted through the first transmission beam, and the CSI-RS may be transmitted through all of the two or more transmission beams.

When the CSI request indicates the SS and the CSI-RS together, and the pre-configured signal is transmitted through two or more transmission beams, the CSI report may be measurement information using the SS for a first transmission beam being used for sidelink communication.

The SS may be transmitted through the first transmission beam, and the CSI-RS may be transmitted on all of the two or more transmission beams.

The CSI request may be transmitted by first-stage sidelink control information (SCI), and the first-stage SCI may include at least one of information indicating absence of second-stage SCI, resource configuration information of the pre-configured signal, information indicating the CSI request, information on a CSI reporting type, information on a number of CSI reports, resource information for a container to be used for CSI reporting, information on a latency bound for CSI reporting, or timing information for CSI reporting.

### Advantageous Effects

The present disclosure provides a procedure for managing beams between a TX UE and an RX UE in sidelink communication. Specifically, a procedure for beam management between the TX UE and RX UE can be implemented using various reference signals, and depending on a situation, an entity requiring beam management, which is the TX UE or the RX UE, can trigger and perform the procedure. Furthermore, through the above-described beam management procedure, an optimal beam can be quickly identified to maintain communication in sidelink communication.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a sequence chart illustrating a case where a TX UE transmits a CSI request.

FIG. 10 is a sequence chart illustrating a case in which an RX UE transmits a beam management request.

FIG. 11 is a sequence chart illustrating a case in which an RX UE transmits a CSI request.

FIG. 12 is a sequence chart illustrating a case where a reception beam is switched based on a CSI request from a TX UE.

FIG. 13 is a sequence chart illustrating a case where a transmission beam is switched based on a CSI request from a TX UE.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g. transmission or reception of a signal) to be performed at a first communication node among communication nodes is described in exemplary embodiments, a corresponding second communication node may perform a method (e.g. reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g. master information block (MIB), system information block (SIB)) and/or an RRC message. The MAC signaling may refer to an operation of transmitting and receiving a MAC control element (CE). The PHY signaling may refer to an operation of transmitting and receiving control information (e.g. downlink control information (DCI), uplink control information (UCI), or sidelink control information (SCI)).

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g. 4G communication networks, 5G communication networks, and/or 6G communication networks). Here, ‘communication network’ may be used interchangeably with a term ‘communication system’.

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g. communication network) 140, and the V2X communications supported by the communication system 140 may be referred to as ‘Cellular-V2X (C-V2X) communications’. Here, the communication system 140 may include the 4G communication system (e.g. LTE communication system or LTE-A communication system), 5G communication system (e.g. NR communication system), and the like.

The V2V communications may include communications between a first vehicle 100 (e.g. a communication node located in the vehicle 100) and a second vehicle 110 (e.g. a communication node located in the vehicle 110). Various driving information such as velocity, heading, time, position, and the like may be exchanged between the vehicles 100 and 110 through the V2V communications. For example, autonomous driving (e.g. platooning) may be supported based on the driving information exchanged through the V2V communications. The V2V communications supported by the communication system 140 may be performed based on sidelink communication technologies (e.g. Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g. road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g. ProSe and D2D communication technologies, and the like). In this case, the communications between the vehicle 100 and the infrastructure 120 may be performed using at least one sidelink channel.

The V2P communications may include communications between the first vehicle 100 (e.g. the communication node located in the vehicle 100) and a person 130 (e.g. a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g. ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g. the communication node located in the vehicle 100) and the communication system (e.g. communication network) 140. The V2N communications may be performed based on the 4G communication technology (e.g. LTE or LTE-A specified as the 3GPP standards) or the 5G communication technology (e.g. NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g. a V2V network slice, a V2I network slice, a V2P network slice, a V2N network slice, etc.) may be configured, and the V2X communications may be supported through the V2X network slices configured in the core network.

The communication nodes (e.g. base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g. base station, relay, UE, S-GW, P-GW, MME, UPF, SMF, AMF, etc.) constituting the communication system may be configured as follows.

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g. single user (SU)-MIMO, multi-user (MU)-MIMO, massive MIMO, etc.), coordinated multipoint (COMP) communication technologies, carrier aggregation (CA) communication technologies, unlicensed band communication technologies (e.g. Licensed Assisted Access (LAA), enhanced LAA (eLAA), etc.), sidelink communication technologies (e.g. ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g. ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g. the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of | Out of coverage of |
| | base station 210 | base station 210 |
| B | In coverage of | Out of coverage of |
| | base station 210 | base station 210 |
| C | In coverage of | In coverage of |
| | base station 210 | base station 210 |
| D | In coverage of | In coverage of |
| | base station 210 | other base station |

Meanwhile, a user plane protocol stack of the UEs (e.g. the UEs 235 and 236) performing sidelink communications may be configured as follows.

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g. PC5-U interface). A layer-2 identifier (ID) (e.g. a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g. the UEs 235 and 236) performing sidelink communications may be configured as follows.

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g. Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g. PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g. UE 235 or 236) by higher layer signaling. The PSCCH may be used for transmitting and receiving sidelink control information (SCI) and may also be configured in the UE (e.g. UE 235 or 236) by higher layer signaling.

The PSDCH may be used for a discovery procedure. For example, a discovery signal may be transmitted over the PSDCH. The PSBCH may be used for transmitting and receiving broadcast information (e.g. system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink TM | Description |
|---|---|
| 1 | Transmission using resources scheduled |
| | by base station |
| 2 | UE autonomous transmission without scheduling |
| | of base station |
| 3 | Transmission using resources scheduled |
| | by base station in V2X communications |
| 4 | UE autonomous transmission without scheduling |
| | of base station in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g. a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g. UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g. UE 235 or 236) within the resource pool configured by the dedicated RRC signaling procedure or the broadcast RRC signaling procedure.

Hereinafter, sidelink communication methods will be described. Even when a method (e.g. transmission or reception of a signal) to be performed at a first communication node among communication nodes is described, a corresponding second communication node may perform a method (e.g. reception or transmission of the signal) corresponding to the method performed at the first communication node. That is, when an operation of a UE #1 (e.g. vehicle #1) is described, a UE #2 (e.g. vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g. SIB12, SIB13, SIB14) and RRC messages including configuration information for sidelink communication (i.e. sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g. SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g. SL-InterUE-CoordinationConfig) including inter-UE coordination parameter(s) to the UE. The UE may perform inter-UE coordination operations based on SL-Inter UE-CoordinationConfig received from the base station.

The sidelink communication may be performed based on a single-SCI scheme or a multi-SCI scheme. When the single-SCI scheme is used, data transmission (e.g. sidelink data transmission, sidelink-shared channel (SL-SCH) transmission) may be performed based on one SCI (e.g. 1st-stage SCI). When the multi-SCI scheme is used, data transmission may be performed using two SCIs (e.g. 1st-stage SCI and 2nd-stage SCI). The SCI(s) may be transmitted on a PSCCH and/or a PSSCH. When the single-SCI scheme is used, the SCI (e.g. 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

Meanwhile, no standard techniques have been developed for beam management in a sidelink (SL) FR2 licensed band. Accordingly, there is a need for development related to beam management in an NR SL FR2 licensed band, as discussed in 3GPP Rel. 18.

In the present disclosure described below, methods for beam management in SL communication will be described. Before describing the methods for beam management in SL communication, a beam management scheme on a Uu interface, which is a radio interface between a base station and a UE, will be described.

First, signals used for channel state information (CSI) measurement are CSI-RS sets or synchronization signal (SS) blocks.

Second, as a metric for CQI measurement for beams, a Layer 1 Reference Signal Received Power (L1-RSRP) is used.

Third, the maximum number of CSIs that can be reported per terminal is 4 (allowing CSI reporting for 4 beams).

Fourth, reporting information may utilize an L1-RSRP of the strongest beam (i.e. beam with the highest reception power) and difference values between the strongest beam and other three beams.

Fifth, CSI-RS transmission types are defined based on a CSI reporting type and a channel used for CSI reporting as follows.
1) Periodic: periodic+PUCCH
2) Semi-persistent: periodic+PUCCH or semi-persistent+PUSCH
3) Aperiodic: aperiodic (triggered by DCI with a CSI request field)+PUSCH

Sixth, beam adjustment needs to be performed for each of downlink transmission and reception beams. Only beam adjustment on downlink is performed if there is beam reciprocity between uplink and downlink.

The details which have been determined in 3GPP standard meetings regarding NR sidelink (SL) are as follows.

First, signals used for CSI measurement are CSI-RS sets.

Second, as a metric for CQI measurement, an L1-RSRP is used.

Third, up to 2-port CSI-RS can be used.

Fourth, CSI-RS transmission types are defined based on a CSI reporting type and a channel used for CSI reporting as follows.

### 1) Aperiodic: Aperiodic (CSI Reporting Triggered by SCI 2-A or SCI 2-C)+MAC-CE (PSSCH)

All reference signals and physical channels referred to in the present disclosure are SL reference signals and physical channels. For SL beam management, a transmitting terminal or a receiving terminal may request beam-related information, and to obtain the beam-related information, the transmitting terminal or the receiving terminal may transmit a CSI-RS. A terminal that receives the CSI-RS may obtain the beam-related information and report the obtained beam-related information.

For beam management, the transmitting and receiving terminals may need to perform CSI-RS transmission, CSI measurement, and CSI reporting operations. Through these procedures, a terminal performing SL communication may switch a transmission beam or reception beam.

In the present disclosure described below, signaling procedures between a transmitting terminal (TX UE) and a receiving terminal (RX UE) according to the present disclosure may be performed. In the present disclosure, the TX UE may refer to a UE that intends to transmit (or has transmitted) data to the RX UE. On the other hand, the RX UE may refer to a UE that receives (or has received) the data from the TX UE. As another example, in SL unicast communication, when establishing an RRC connection therebetween, the TX UE and RX UE may be designated as the transmitting and receiving UEs, respectively.

In the following, four exemplary embodiments of the present disclosure will be described. However, the present disclosure is not limited to the four exemplary embodiments described below and may include modifications or extensions thereof, or combinations with other exemplary embodiments.

### First Exemplary Embodiment

The first exemplary embodiment according to the present disclosure may correspond to a scheme in which a TX UE transmits a CSI request and a CSI-RS to an RX UE, and the RX UE reports CSI to the TX UE.

FIG. 9 is a sequence chart illustrating a case where a TX UE transmits a CSI request.

As shown in FIG. 9, a TX UE 901 and RX UE 902 are illustrated, and each of them may be an entity performing procedures shown in FIG. 9. The TX UE 901 and

RX UE 902 shown in FIG. 9 may each be a communication node located in the vehicle 100 or 110 or infrastructure 120, or a communication node carried by the person 130 as shown in FIG. 1. Additionally, each of the TX UE 901 and RX UE 902 may include at least part or all of the components described earlier in FIG. 3, or may have additional components. Furthermore, each of the TX UE 901 and RX UE 902 may include at least part of the components described in FIGS. 4 to 8.

Referring to FIG. 9, procedures of the TX UE 901 and RX UE 902 according to the present disclosure will be described.

In step S910, the TX UE 901 may transmit a channel state information (CSI) request to the RX UE 902. The CSI request transmitted by the TX UE 901 may be a message or signal for triggering a CSI report of the RX UE 902. Additionally, the CSI request transmitted by the TX UE 901 to the RX UE 902 may be indicated using first-stage SCI and/or second-stage SCI. As another example, the CSI request transmitted by the TX UE 901 to the RX UE 902 may be indicated through a MAC-CE. Alternatively, the CSI request transmitted by the TX UE 901 to the RX UE 902 may be indicated through a combination of two or more among first-stage SCI, second-stage SCI, and MAC-CE.

In step S910, the RX UE 902 may receive the CSI request from the TX UE 901 based on one of the schemes described above.

In step S920, the TX UE 901 may transmit a CSI-RS to the RX UE 902. The CSI-RS transmitted by the TX UE 901 may be transmitted in a (pre) defined time-frequency resource region or a resource region configured through the CSI request message. Additionally, when transmitting the CSI-RS to the RX UE 902, the TX UE 901 may transmit the CSI-RS by using one or more transmission beams available to the TX UE 901. If two or more transmission beams are used, the TX UE 901 may transmit the CSI-RS by sweeping the transmission beams.

If the CSI request is indicated through SCI in step S910, the SCI including the CSI request may indicate configuration information such as a time resource, frequency resource, transmission pattern, transmission density, and a type of CSI to be reported, related to the CSI-RS transmission. In this case, the TX UE 901 may transmit the CSI-RS to the RX UE 902 in step S920 based on configuration information of a SL slot that includes the SCI including the CSI request. Additionally, in step S920, the TX UE 901 may transmit other types of reference signals, such as a synchronization signal (SS) in a specific time-frequency resource region configured for CSI-RS transmission or a demodulation reference signal (DMRS) in the same slot, to the RX UE 902. Therefore, when the CSI request is indicated through SCI, the operations of steps S910 and S920 may occur within a single SL slot. Alternatively, the operations of steps S910 and S920 may occur within a single SL slot and in the configured resource region for SS transmission.

As another example, even if the CSI request is indicated through SCI, the CSI-RS transmission may occur in a different slot. For instance, the SCI may instruct that a CSI-RS transmitted in a specific slot to be measured and reported. As a specific example, the SCI including the CSI request may be transmitted in a slot #1, and the SCI may instruct measurement and reporting of a CSI-RS transmitted in a slot #2 or slot #3. As another specific example, the SCI including the CSI request may be transmitted in a slot #1, and the SCI may instruct measurement and reporting of a CSI-RS transmitted in a specific slot after a few slots from the current slot.

In the following description, for convenience of description, it is assumed that the operations of steps S910 and S920 are performed within a single SL slot when the CSI request is indicated through SCI.

In step S920, the RX UE 902 may receive the CSI-RS from the TX UE 901 through one or multiple beams based on the schemes described above. Additionally, the RX UE 902 may receive, through one or multiple beams from the TX UE 901, reference signals such as SS and/or DMRS in addition to the CSI-RS.

The RX UE 902 may receive the CSI-RS transmitted through the beam(s) in step S920 based on the CSI request received in step S910. If multiple beams are received, the RX UE 902 may measure channel state information (CSI) for each of the beams.

In step S930, the RX UE 902 may transmit a CSI report to the TX UE 901 through sidelink. When transmitting the CSI report to the TX UE 901, the RX UE 902 may report the measured CSI through a PSSCH or a MAC-CE associated with the PSSCH.

If the RX UE 902 measures CSI for multiple beams, the RX UE 902 may report only an optimal beam and CSI corresponding to the optimal beam during the CSI reporting. As another example, if the RX UE 902 measures CSI for multiple beams, the RX UE 902 may report CSI for each of the beams during the CSI reporting. As yet another example, if the RX UE 902 measures CSI for multiple beams, the RX UE 902 may include an optimal beam and CSI corresponding to the optimal beam in the CSI report while reporting only a difference from the CSI of the optimal beam for each of other beams.

The TX UE 901 may determine a transmission beam based on the CSI report received from the RX UE 902. The determined transmission beam may be a beam currently used for SL communication or a new beam. If the TX UE 901 intends to perform SL communication using a new beam, the TX UE 901 may notify the RX UE 902 of beam switching.

Meanwhile, in the above description, the operation where the TX UE 901 transmits the CSI-RS request to the RX UE 902 using first-stage SCI and second-stage SCI (step S910) and transmits the CSI-RS to the RX UE 902 based on the first-stage SCI and the second-stage SCI (step S920) has been described. In other words, it has been described under assumption that first-stage SCI corresponds to the SCI format 1-A as defined in the 3GPP Rel. 17.

As another approach in FIG. 9, the TX UE 901 may transmit a CSI-RS request to the RX UE 902 using only first-stage SCI (step S910) and transmit a CSI-RS to the RX UE 902 based on the first-stage SCI. In other words, second-stage SCI may not be used.

The present disclosure further proposes a method using new first-stage SCI to transmit a CSI-RS request to the RX UE 902 using only the first-stage SCI. For convenience of description, the new first-stage SCI according to the present disclosure will be referred to as a SCI format 1-B.

The SCI format 1-B may include all or portion of information described below. As another example, the TX UE 901 and RX UE 902 may receive multiple pieces of configuration information for all or portion of the information described below from the base station through higher layer signaling. The TX UE 901 and RX UE 902 may operate in a manner of being indicated, through the SCI format 1-B, a portion of the information received through higher layer signaling. For convenience of description, the following description assumes that the SCI format 1-B is transmitted as including all configuration information described below.

Information included in SCI format 1-B:
Indication information for first-stage SCI operation or information indicating absence of second-stage SCI
Information on a PSSCH DMRS pattern and the number of ports
Time-frequency resource configuration information for SL-SSB transmission
Configuration information on transmission beams used for SL-SSB transmission
Configuration information on a SL CSI-RS transmission pattern and time-frequency resources for SL CSI-RS transmission
Configuration information on transmission beams used for SL CSI-RS transmission
Configuration information on reference signals used for beam measurement
CSI request indication information
Configuration information related to CSI reporting, such as types and number of CSI to be reported, time-frequency resource configuration for a container or physical channel used for CSI reporting, and a latency bound or timing configuration for CSI reporting.

The above describes an example of the information included in the SCI format 1-B. However, additional information may be defined in addition to the information described above, as needed.

Another approach of the present disclosure is to operate with second-stage SCI but define a new second-stage SCI format different from three types of SCI format 2 defined in the 3GPP Rel. 17 to achieve efficient beam management. For convenience of description, the newly defined second-stage SCI in the present disclosure is referred to as a SCI format 2-D.

The SCI format 2-D may include all or portion of the following information. As another example, multiple pieces of configuration information for all or portion of the information below may be received from the base station through higher layer signaling. The TX UE 901 and RX UE 902 may operate in a manner of being indicated, through the SCI format 2-D, a portion of the information received through higher layer signaling.

Information included in SCI format 2-D:
Configuration information on time-frequency resources for SL-SSB transmission
Configuration information on transmission beams used for SL-SSB transmission
Configuration information on a SL CSI-RS transmission pattern and time-frequency resources for SL CSI-RS transmission
Configuration information on transmission beams used for SL CSI-RS transmission
Configuration information on reference signals used for beam measurement
CSI report indication information
Configuration information related to CSI reporting, such as types and number of CSI to be reported, time-frequency resource configuration for a container or physical channel used for reporting, and a latency bound or timing configuration for reporting.

The above describes an example of the information included in SCI format 2-D. However, additional information other than the information described above may be defined as needed.

When the time-frequency resources for CSI-RS transmission use a PSSCH resource region, in other words, when a portion of a PSSCH resource region is allocated as the time-frequency resources for CSI-RS transmission, the time-frequency resources for CSI-RS transmission may be configured in conjunction with PSSCH resource configuration information.

As another example, a specific time-frequency resource region within the SL slot may be preconfigured for CSI-RS transmission, and the CSI-RS may be transmitted in the specific resource region.

Among the configuration information included in the SCI format 1-B and SCI format 2-D described above, ‘resource configuration for SSB transmission’ and ‘configuration information on SSB transmission beams’ refer to information related to SL synchronization signals transmitted by the SL terminal. Therefore, the TX UE 901 may indicate at least one of the following using configurations of the SCI format 1-B or SCI format 2-D: whether to transmit SSB(s), time-frequency resource information used for SSB transmission, periodicity information related to SSB transmission, transmission beam switching pattern used for SSB transmission, and whether to switch the transmission beam.

As described above, efficient beam management can be performed in SL communication by utilizing the SCI format 1-B and SCI format 2-D.

Among the configuration information included in the SCI format 1-B and SCI format 2-D, ‘configuration information on reference signals used for beam information measurement’ may include information on a DMRS of a PSSCH or SS signals in addition to the CSI-RS for beam management. When the SCI format 1-B and SCI format 2-D include information on a DMRS of a PSSCH or SS signals, a common measurement scheme for different signals may be applied. Through this, the DMRS of the PSSCH or SS signals may be used for beam information measurement and reporting, in addition to the CSI-RS.

Meanwhile, the configuration information on reference signals used for beam information measurement, including the DMRS or SS in addition to the CSI-RS, may be illustrated as in Table 3 below.

TABLE 3

| Identifier of configuration | |
|---|---|
| information for beam | |
| information measurement | Configured signals |
| 00 | CSI-RS |
| 01 | DM-RS, CSI-RS |
| 10 | SS |
| 11 | SS, CSI-RS |

For the information exemplified in Table 3, identifiers may be configured and transmitted to the TX UE 901 and RX UE 902 through higher-layer signaling for a portion or all of the overall CSI-RS resource sets. Therefore, based on the higher-layer signaling, the TX UE 901 and RX UE 902 may measure CSI for a CSI-RS resource set of which identifier configured described above is received by using the corresponding signal(s) in step S920 of FIG. 9. The configuration information in Table 3 may be operated in a resource pool (RP)-specific or SL-specific manner.

When using the configuration scheme based on Table 3, beam information may be measured in various manners based on operational combinations of ‘configured signals’. This is illustrated using the following three examples.

Operational Example #1: The RX UE 902 may measure information on a transmission beam based on the SS signal and may subsequently refine the transmission beam based on the CSI-RS.

Operational Example #2: The RX UE 902 may measure information on a transmission beam based on the SS signal and may subsequently refine a reception beam corresponding to the transmission beam based on the CSI-RS.

Operational Example #3: The RX UE 902 may measure information on a currently used transmission beam within a SL slot by utilizing the DMRS, and the TX UE 901 may transmit the CSI-RS using a beam other than the currently used beam. Using such transmission, the system may be configured and operated to measure information on other transmission beams.

Operational Example 4: The RX UE 902 may measure information on a currently used transmission beam within a SL slot using the DMRS, and the TX UE 901 may transmit the CSI-RS using the same beam as the currently used beam, which is the beam transmitting the DMRS. By utilizing this transmission scheme, the RX UE 902 may measures information on a reception beam for the transmission beam and may switch the reception beam. In this case, the currently used beam for transmitting the DMRS is a beam switched through a transmission beam switching procedure and may be applied and used for a purpose of adjusting the reception beam for the transmission beam.

In Operational Examples 1 and 2 described above, the TX UE 901 may indicate to the RX UE 902 whether the reference signal transmitted through the currently transmission beam is a reference signal for measuring the transmission beam or a reference signal for refining the reception beam. This indication information may be included in first-stage SCI or second-stage SCI.

If first-stage SCI is used, the newly proposed SCI format 1-B in the present disclosure may be applied as described earlier. If second-stage SCI is used, the newly proposed SCI format 2-D in the present disclosure may be applied. In other words, information on the beam used for SS, DMRS, and CSI-RS transmission may be indicated through the SCI proposed in the present disclosure.

In Operational Examples 3 and 4 described above, the TX UE 901 may indicate to the RX UE 902 whether the reference signal transmitted through the currently transmission beam is a reference signal for measuring the transmission beam or a reference signal for refining the reception beam. This indication information may be included in first-stage SCI or second-stage SCI.

If first-stage SCI is used, the newly proposed SCI format 1-B in the present disclosure may be applied as described earlier. If second-stage SCI is used, the newly proposed SCI format 2-D in the present disclosure may be applied. In other words, information on the beam used for SS, DMRS, and CSI-RS transmission may be indicated through the SCI proposed in the present disclosure.

The indication information for transmission beam switching or reception beam switching may be included in the CSI request and CSI report configuration information and transmitted accordingly.

Table 4 is an example of a table mapping a CSI report configuration identifier to the CSI report information according to the present disclosure.

TABLE 4

| Identifier of CSI report | |
|---|---|
| configuration information | CSI report information |
| 00 | CQI, RI |
| 01 | BI, BQI |
| 10 | N/A or BQI |
| 11 | CQI, RI, BI, BQI |

In describing Table 4, for convenience of description, the CSI for beam management purposes may be referred to as a beam index (BI) and beam quality information (BQI). The RX UE 902 may transmit multiple BIs and BQIs when reporting CSI. In this case, each BQI may be configured as a Reference Signal Received Power (RSRP) or Layer 1 RSRP (L1-RSRP) for the corresponding beam. As another example, each BQI may be configured as a difference between an RSRP or L1-RSRP of a reference beam and an RSRP or L1-RSRP of a measured beam that differs from the reference beam. The reference beam may be the currently used beam or a beam with the highest measured quality.

In Table 4, when the CSI report configuration identifier is set to ‘00’. The TX UE 901 may configure channel quality information (CQI) and rank indicator (RI) as CSI report information for the RX UE 902. When indicated to configure CQI and RI as CSI report information, the TX UE 901 may instruct the RX UE 902 to measure CQI and RI based on reference signals configured for beam information measurement rather than beam information, and to report the measured results. Additionally, the TX UE 901 may implicitly instruct the RX UE 902 to measure only the CSI-RS when configuring reporting of CQI and RI.

In Table 4, when the CSI report configuration identifier is set to ‘01’. the TX UE 901 may configure BI and BQI as CSI report information for the RX UE 902. When indicated to configure BI and BQI as CSI report information, the TX UE 901 may implicitly indicate to the RX UE 902 that the signals configured for beam information measurement are transmitted through different beams. Therefore, the TX UE 901 may instruct the RX UE 902 to report BI and BQI for each of measured beams, or to report BI(s) and BQI(s) for all or a portion of measured beams.

In Table 4, when the CSI report configuration information identifier is set to ‘10’, the TX UE 901 may instruct the RX UE 902 not to report anything as CSI report information. Therefore, the TX UE 901 may implicitly instruct the RX UE 902 to switch the reception beam based on the measured information. As another example, the TX UE 901 may configure the RX UE 902 to report only BQI without BI. Thus, the TX UE 901 may implicitly instruct the RX UE 902 to switch the reception beam based on the measured information. In this case, the TX UE 901 may configure the RX UE 902 to report only a SL channel quality for the switched reception beam, that is, a BQI. Accordingly, when the TX UE 901 subsequently switches the transmission beam, the TX UE 901 may utilize the BQI received from the RX UE 902.

In Table 4, when the CSI report configuration information identifier is set to ‘11’, the TX UE 901 may configure the RX UE 902 to report CQI, RI, BQI, and BI as CSI report information. Therefore, the TX UE 901 may instruct the RX UE 902 to report CQI and RI for a currently used transmission beam and to report BI and BQI measured from other configured signals.

In addition to the information exemplified in Table 4 as described above, various combinations of transmission of SS, DMRS, and CSI-RS, as well as measurement reporting for these signals, may be applied. Moreover, various combinations may be utilized for CSI measurement, reporting of measured CSI, and beam management.

### Second Exemplary Embodiment

The second exemplary embodiment according to the present disclosure may correspond to a scheme in which the RX UE transmits a beam management request to the TX UE, and the TX UE then transmits a CSI request and a CSI-RS, allowing the RX UE to report CSI.

FIG. 10 is a sequence chart illustrating a case in which an RX UE transmits a beam management request.

FIG. 10 illustrates the TX UE 901 and RX UE 902 as illustrated in FIG. 9. Each of the TX UE 901 and RX UE 902 may be an entity performing a procedure shown in FIG. 10. Each of the TX UE 901 and RX UE 902 shown in FIG. 10 may be one of a communication node located in the vehicle 100 or 110, infrastructure 120, or communication node held by the person 130 shown in FIG. 1. Additionally, each of the TX UE 901 and RX UE 902 shown in FIG. 10 may include at least part or all of the components described in FIG. 3 or may have additional components. Furthermore, the TX UE 901 and RX UE 902 shown in FIG. 10 may include at least part of the components described in FIGS. 4 to 8.

Referring to FIG. 10, the procedure of the TX UE 901 and RX UE 902 according to the present disclosure will be described.

In step S1010, the RX UE 902 may transmit a beam management (BM) request to the TX UE 901. The BM request transmitted by the RX UE 902 may be a message or signal for triggering transmission of a CSI-RS for beam management by the TX UE 901.

In step S1010, the TX UE 901 may receive the BM request from the RX UE 902. In response to the BM request, the TX UE 901 may prepare a CSI request message and transmission of a CSI-RS for beam management.

In step S1020, the TX UE 901 may transmit the CSI request message and CSI-RS for beam management to the RX UE 902 through one or more beams available for transmission by the TX UE 901.

In this case, the CSI request message may include time-frequency resource information for CSI-RS transmission and/or configuration information regarding the types of CSI to be reported during CSI reporting.

If two or more transmission beams are used for CSI-RS transmission, the TX UE 901 may transmit the CSI-RS by sweeping the transmission beams. Accordingly, in step S1020, the RX UE 902 may receive the CSI-RS for beam management through one or more beams in a predefined or configured time-frequency resource region or in a time-frequency resource region for CSI-RS transmission indicated by the CSI request message. The RX UE 902 may then measure the CSI-RS for beam management.

In this case, CSI-RS measurement may be performed for all received beams. For example, when the TX UE 901 transmits the CSI-RS by sweeping four beams, the RX UE 902 may measure the CSI-RS received through each of the four beams and obtain the corresponding CSI values.

In step S1030, the RX UE 902 may report the measured CSI to the TX UE 901. When the CSI-RS is transmitted through multiple beams, the RX UE 902 may report only a CSI value for a beam with the highest reception quality to the TX UE 901. As another example, when the CSI-RS is transmitted through multiple beams, the RX UE 902 may report a CSI value for a beam with the highest reception quality in the report and report difference values for the remaining beams relative to the CSI value with the highest reception quality. As another example, when the CSI-RS is transmitted through multiple beams, the RX UE 902 may report CSI values for all beams to the TX UE 901.

The operations in FIG. 10, where the RX UE 902 transmits a BM request to the TX UE 901, the TX UE 901 transmits a CSI request message and CSI-RS to the RX UE 902, and the RX UE 902 reports CSI to the TX UE 901, have been described. The signaling procedure described in FIG. 10 may be modified, extended, or combined with other examples in the same manner as described for the exemplary embodiment in FIG. 9.

As a variation of the method described in FIG. 10, in step S1020, when the TX UE 901 transmits the CSI-RS to the RX UE 902, the TX UE 901 may transmit other reference signals, such as SS or DMRS, in addition to the CSI-RS.

The following advantages may be obtained when the RX UE 902 is configured to transmit the BM request, as shown in FIG. 10. The RX UE 902 can determine a good or bad state of a beam being used for SL communication with the TX UE 901 at the earliest possible time. The RX UE 902 can determine a good or bad state of the beam by utilizing a signal quality of a SS, PSCCH, PSSCH, DMRS associated with a PSCCH, DMRS associated with a PSSCH, CSI-RS, and/or the like. Therefore, the RX UE 902 may transmit the BM request to the TX UE 901 based on the signal quality of one of the above-described signals.

To enable the RX UE 902 to transmit the BM request, the TX UE 901 may instruct the RX UE 902 to periodically measure a specific signal through higher-layer signaling such as RRC and/or MAC-CE or SCI. In this case, the specific measurement target may be configured in the RP-specific or SL-specific manner.

For example, the TX UE 901 may configure the RX UE 902 to periodically measure at least one of a DMRS of a PSSCH, CSI-RS transmitted through the currently used beam, SS transmitted through the currently used beam, or DMRS of a PSCCH.

Based on results of the measurement, if a signal quality falls below a predetermined threshold, the RX UE 902 may transmit the BM request to the TX UE 901. In this case, the signal quality may be determined as a value such as (L1-)RSRP. The threshold for the signal quality may be indicated through higher-layer signaling such as RRC and/or MAC-CE or SCI transmitted by the TX UE 901. In this case, the measurement target may also be configured in the RP-specific or SL-specific manner.

As another example, the BM request may be triggered if a certain number of NACKs occur for sidelink data transmitted by the TX UE 901. A NACK may occur when demodulation and/or decoding of the sidelink data transmitted by the TX UE 901 fails. In this case, specific condition(s) may be configured through higher-layer signaling such as RRC and/or MAC-CE or indicated by SCI transmitted by the TX UE 901 in the RP-specific or SL-specific manner.

A container for transmitting the BM request may be a SL container transmitted through a SL communication scheme by which the RX UE 902 transmits and the TX UE 901 receives. In this case, the BM request may be transmitted through a PSCCH, a PSSCH, or a MAC-CE of a PSSCH in the SL. If the BM request is indicated using SCI, a CSI request field in second-stage SCI (e.g. SCI format 2-A or SCI format 2-C) may be used as a BM request field.

Additionally, the RX UE 902 may indicate and transmit, along with the BM request signal, whether a beam measurement process for reception beam switching is required. For example, if the RX UE 902 has already measured SL quality through reception beam switching and determines that transmission beam switching is required to improve the SL quality, the RX UE 902 may indicate that the beam measurement process for reception beam switching is not required. In this case, the TX UE 901 may not perform operations such as CSI-RS transmission using the same transmission beam. In other words, the TX UE 901 may refrain from transmitting CSI-RS using the same transmission beam, thereby avoiding the reception beam switching and beam information measurement procedure at the RX UE 902.

Conversely, if the RX UE 902 identifies potential for SL quality improvement through reception beam switching, the RX UE 902 may indicate in the BM request that the beam measurement process for reception beam switching is required.

When the BM request indicates reception beam switching, the TX UE 901 may transmit reference signals using the same transmission beam for reception beam switching. Specifically, when the TX UE 901 transmits reference signals using a single transmission beam, the TX UE 901 may transmit symbols including reference signals for beam management multiple times or over multiple slots.

Information indicating whether the beam measurement process for reception beam switching is required may be explicitly or implicitly indicated by assigning an additional 1-bit field in the container for the BM request.

Alternatively, a PSFCH within a SL slot may be used as the container for transmitting the BM request. In this case, a necessity of performing the BM process may be indicated by transmitting a specific sequence or 1-bit information. When the necessity of the beam measurement process for reception beam switching is indicated together, two specific sequences may be configured for operation. For example, one of the two sequences may indicate the BM request, and the other sequence may indicate the necessity of the beam measurement process for reception beam switching.

If the information is transmitted using bit-based signaling, 2 bits may be used to indicate the necessity of performing the BM process and the necessity of the beam measurement process for reception beam switching.

As another example, the RX UE 902 may indicate the necessity of beam measurement for transmission beam switching instead of indicating the necessity of beam measurement for reception beam switching.

Meanwhile, using the operations described with reference to Tables 3 and 4 in the first exemplary embodiment (e.g. Operational Examples #1 to #4) may be applied to the second exemplary embodiment in the same manner. Therefore, the first-stage SCI according to the present disclosure, namely SCI format 1-B, may also be applied to the second exemplary embodiment. Additionally, the second-stage SCI according to the present disclosure, namely SCI format 2-D, may also be applied to the second exemplary embodiment.

Since the operations of these aspects can be carried out from the same perspective as in the first exemplary embodiment, redundant descriptions are omitted.

The procedures of FIG. 10 described above may also be applied in the same manner as the operational examples described in FIG. 9. Furthermore, based on the content described in FIG. 10, modifications, extensions, or combinations with other exemplary embodiments may also be utilized.

### Third Exemplary Embodiment

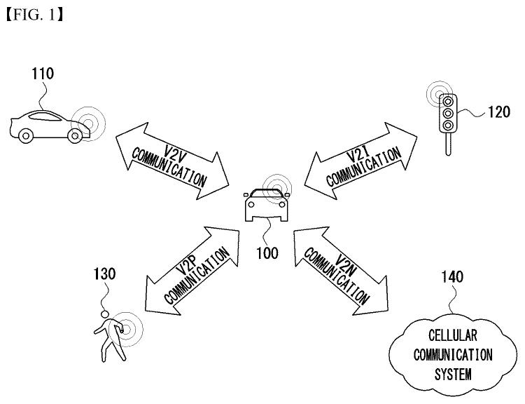

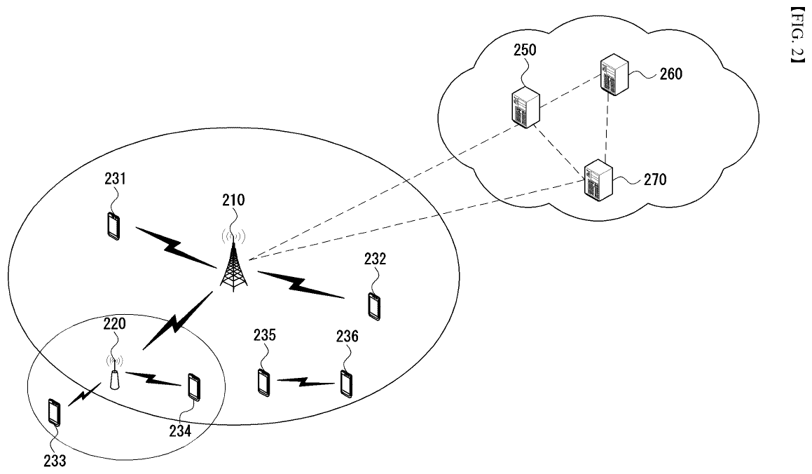

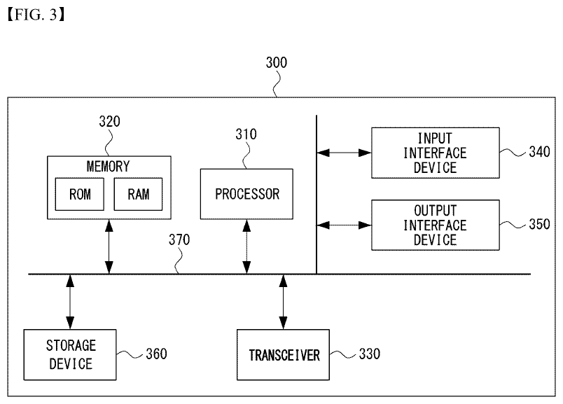

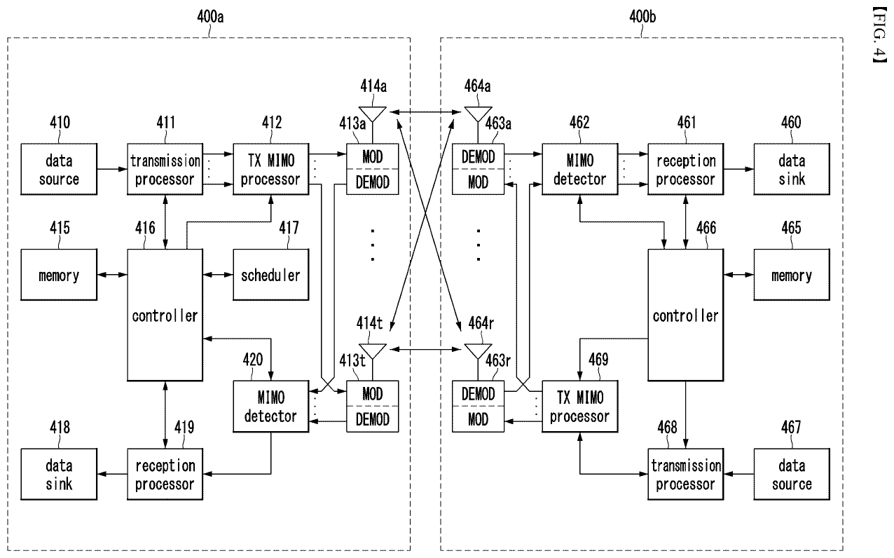

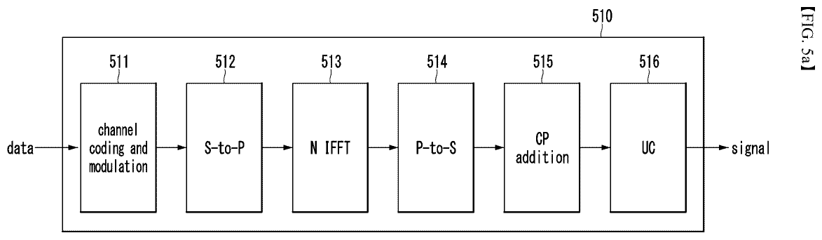

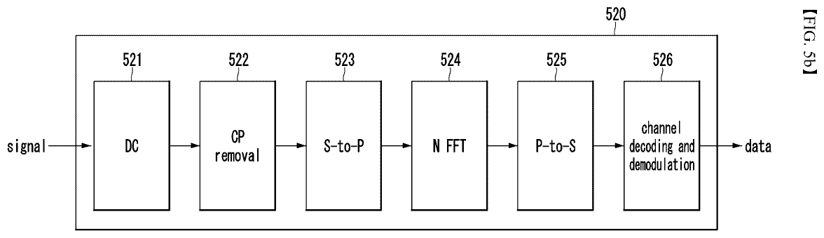

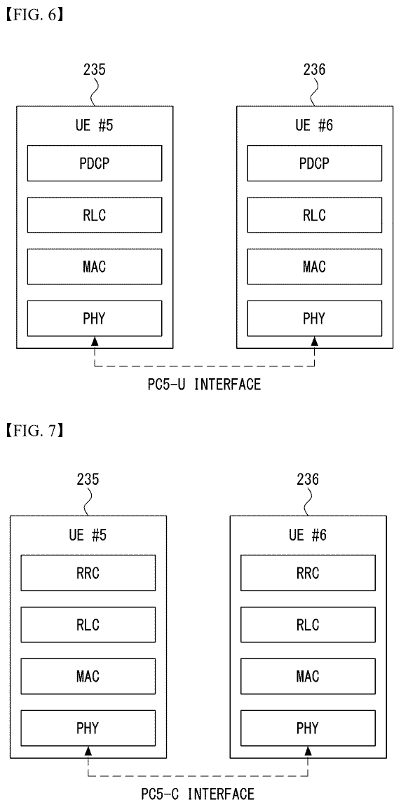

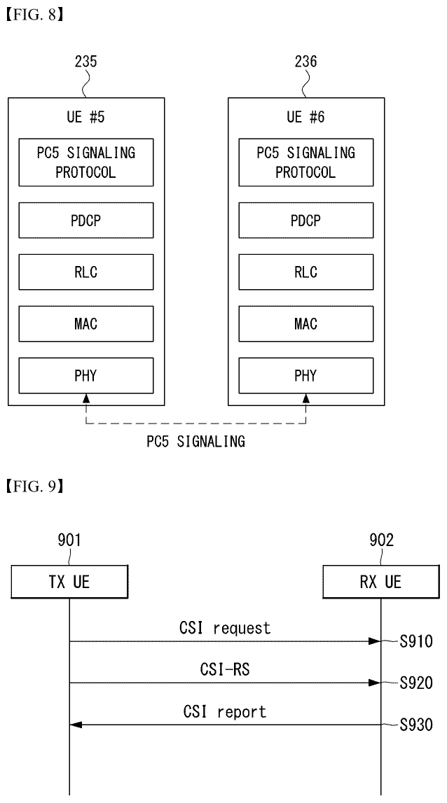

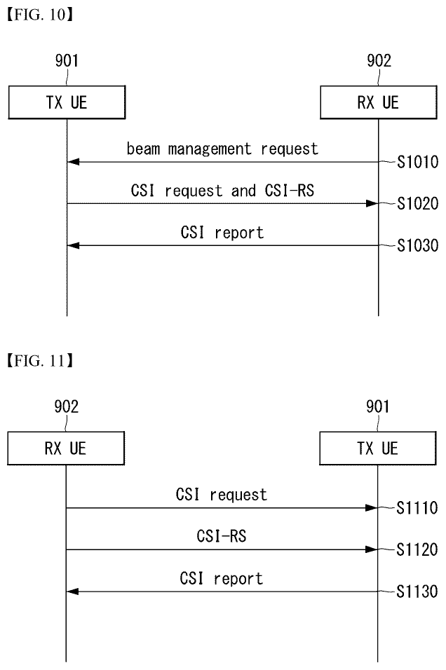

FIG. 11 is a sequence chart illustrating a case in which an RX UE transmits a CSI request.

FIG. 11 illustrates the TX UE 901 and RX UE 902, and each of the TX UE 901 and RX UE 902 may be an entity performing a procedure shown in FIG. 11. Each of the TX UE 901 and RX UE 902 shown in FIG. 11 may be one of a communication node located in the vehicle 100 or 110, infrastructure 120, or communication node held by the person 130 shown in FIG. 1. Additionally, each of the TX UE 901 and RX UE 902 may include at least part or all of the components described in FIG. 3 or may have additional components. Furthermore, the TX UE 901 and RX UE 902 may include at least part of the components described in FIGS. 4 to 8.

Referring to FIG. 11, the procedure of the TX UE 901 and RX UE 902 according to the present disclosure will be described.

In step S1110, the RX UE 902 may transmit a CSI request to the TX UE 901. The CSI request transmitted by the RX UE 902 may be a message or signal for triggering CSI reporting by the TX UE 901. Additionally, the CSI request transmitted by the RX UE 902 to the TX UE 901 may be indicated using first-stage SCI and/or second-stage SCI. As another example, the CSI request transmitted by the RX UE 902 to the TX UE 901 may be indicated through a MAC-CE. As yet another example, the CSI request transmitted by the RX UE 902 to TX UE 901 may be indicated through a combination of two or more among first-stage SCI, second-stage SCI, and MAC-CE.

In step S1110, the TX UE 901 may receive the CSI request from the RX UE 902 based on one of the scheme described above.

In this case, the CSI request message may include time-frequency resource information for CSI-RS transmission. Additionally, the CSI request message may include configuration information regarding types of CSI to be reported during CSI reporting. In other words, the CSI request message may include time-frequency resource information for CSI-RS transmission and/or configuration information regarding the types of CSI to be reported during CSI reporting.

In step S1120, the RX UE 902 may transmit a CSI-RS to the TX UE 901. The CSI-RS transmitted by the RX UE 902 may be transmitted in a (pre) defined time-frequency resource region or in a time-frequency resource region configured through the CSI request message. Furthermore, the RX UE 902 may transmit the CSI-RS to the TX UE 901 through one or more beams, as described in the first and second exemplary embodiments.

If the CSI request in step S1110 is indicated through SCI, the SCI including the CSI request may indicate configuration information of at least one of a time resource, frequency resource, transmission pattern, transmission density, or types of CSI to be reported, which are related to CSI-RS transmission. In this case, the RX UE 902 may transmit the CSI-RS in step S1120 to the TX UE 901 through one or more beams based on configured information of a SL slot including the SCI with the CSI request. If the CSI-RS is transmitted through more than one beam, the CSI-RS may be transmitted through beam sweeping.

Additionally, in step S1120, the RX UE 902 may transmit other types of reference signals, such as SS or DMRS, to the TX UE 901 in the same slot as the CSI-RS transmission. Therefore, when the CSI request is indicated through the SCI, the operations in steps S1110 and S1120 may be performed within a single SL slot.

As another example, even if the CSI request is indicated through SCI, CSI-RS transmission may occur in a different slot. For example, the SCI may instruct measurement and reporting of a CSI-RS transmitted in a specific slot. As a specific example, the SCI including the CSI request may be transmitted in a slot #1, and the SCI may instruct the measurement and reporting of a CSI-RS transmitted in a slot #2 or slot #3. As another specific example, the SCI including the CSI request may be transmitted in a slot #1, and the SCI may instruct the measurement and reporting of a CSI-RS transmitted in a slot after a specific number of slots from the current slot #1.

In step S1120, the TX UE 901 may receive the CSI-RS from the RX UE 902 based on the schemes described above. Additionally, the TX UE 901 may receive SS or DMRS from the RX UE 902 in addition to the CSI-RS.

In step S1110 and step S1120, the TX UE 901 may receive the CSI request and the CSI-RS transmitted through specific beam(s), and measure CSI.

In step S1130, the TX UE 901 may transmit a CSI report to the RX UE 902 through the SL. When the TX UE 901 transmits the CSI report to the RX UE 902, the measured CSI may be reported through a PSSCH or a MAC-CE associated with the PSSCH.

In FIG. 11 described above, the RX UE 902 can quickly determine whether a beam currently being used for SL communication with the TX UE 901, in other words, a SL communication state, is in a good or bad state. The RX UE 902 can determine a beam state by measuring one of a SS, PSCCH, PSSCH, a DMRS associated with a PSCCH, DMRS associated with a PSSCH, or CSI-RS that the TX UE 901 transmits to the RX UE 902 through specific beam(s).

Therefore, the example in FIG. 11 may be a procedure in which the RX UE 902 performing SL communication triggers CSI reporting based on a quality of a specific signal transmitted by a beam of the TX UE 901.

The example in FIG. 11 described above follows the same procedure as the example in FIG. 9, but the triggering entity may differ. Thus, apart from the triggering entity, the remaining operations may be performed in the same manner as described in the example in FIG. 9.

Meanwhile, using the operations described with reference to Tables 3 and 4 in the first exemplary embodiment (e.g. Operational Examples #1 to #4) may be applied in the third exemplary embodiment in the same manner. Therefore, the third exemplary embodiment may also use the first-stage SCI according to the present disclosure, namely SCI format 1-B. Additionally, the third exemplary embodiment may also use the second-stage SCI according to the present disclosure, namely SCI format 2-D.

Since the operations of these aspects can be carried out from the same perspective as in the first exemplary embodiment, redundant descriptions are omitted.

Furthermore, the BM request operation method in FIG. 10 may be simply applied or applied in a modified form to the CSI request operation in FIG. 11. The overall operation in FIG. 11 may be used in combination with at least one of the methods described in FIG. 9 and FIG. 10.

### Fourth Exemplary Embodiment

When performing the beam management procedure according to the present disclosure, the operations may differ depending on whether beam reciprocity is established or not. Here, beam reciprocity refers to a case where the TX UE 901 and the RX UE 902 use the same beam for both transmission and reception of SL data between the TX UE 901 and RX UE 902. In other words, beam reciprocity may refer to a case where a beam used by the TX UE 901 to transmit SL data to the RX UE 902 and a beam used by the TX UE 901 to receive the SL data from the RX UE 902 are the same. This applies equally to the RX UE 902.

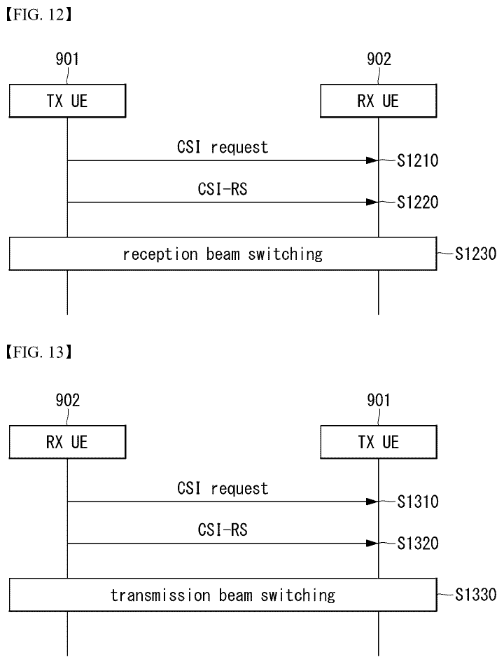

As an example, in an environment with beam reciprocity, a signaling flow described in FIG. 12 and/or FIG. 13 may be used to minimize CSI reporting overhead during beam management. Referring to FIG. 12 and FIG. 13, a reception (RX) beam switching procedure and a transmission (TX) beam switching procedure in the environment with beam reciprocity will be described.

FIG. 12 is a sequence chart illustrating a case where a reception beam is switched based on a CSI request from a TX UE.

Each of the TX UE 901 and RX UE 902 illustrated in FIG. 12 may serve as an entity performing a procedures of FIG. 12. Additionally, as described in FIG. 9 to FIG. 11, each of them may be one of the communication nodes of FIG. 1 and may include at least part or all of the components described in FIG. 3. Furthermore, each of them may include at least part of the components described in FIG. 4 to FIG. 8.

In step S1210, the TX UE 901 may transmit a CSI request to the RX UE 902. The CSI request transmitted by the TX UE 901 may be a message or signal for triggering CSI reporting by the RX UE 902. Additionally, the CSI request transmitted by the TX UE 901 to the RX UE 902 may be indicated using first-stage SCI and/or second-stage SCI. As another example, the CSI request transmitted by the TX UE 901 to the RX UE 902 may be indicated through a MAC-CE. As yet another example, the CSI request transmitted by the TX UE 901 to the RX UE 902 may be indicated through a combination of two or more among first-stage SCI, second-stage SCI, and MAC-CE.

In step S1210, the RX UE 902 may receive the CSI request from the TX UE 901 based on one of the schemes described above.

In step S1220, the TX UE 901 may transmit a CSI-RS to the RX UE 902. The CSI-RS transmitted by the TX UE 901 may be transmitted in a (pre) defined time-frequency resource region or in a time-frequency resource region configured through the CSI request message. Additionally, in step S1220, the TX UE 901 may transmit the CSI-RS through multiple beams that the TX UE 901 can use for transmission or through a single beam, for example, a beam used for sidelink communication. If the CSI-RS is transmitted through multiple beams, the CSI-RS is transmitted through beam sweeping.

If the CSI request in step S1210 is indicated through SCI, the SCI including the CSI request may indicate configuration information of at least one of a time resource, frequency resource, transmission pattern, transmission density, or types of CSI to be reported, which are related to CSI-RS transmission. In this case, the TX UE 901 may transmit the CSI-RS in step S1220 to the RX UE 902 based on configured information of a SL slot including the SCI with the CSI request. Furthermore, in step S1220, the TX UE 901 may transmit other types of reference signals, such as SS or DMRS, to the RX UE 902 in the same slot as the CSI-RS transmission. Therefore, when the CSI request is indicated through SCI, the operations in step S1210 and step S1220 may be performed within a single SL slot.

As another example, even if the CSI request is indicated through SCI, CSI-RS transmission may occur in a different slot. For example, the SCI may instruct measurement and reporting of a CSI-RS transmitted in a specific slot. As a specific example, the SCI including the CSI request may be transmitted in a slot #1, and the SCI may instruct the measurement and reporting of a CSI-RS transmitted in a slot #2 or slot #3. As another specific example, the SCI including the CSI request may be transmitted in a slot #1, and the SCI may instruct the measurement and reporting of a CSI-RS transmitted in a slot after a specific number of slots from the current slot #1.

For convenience of description, the following description assumes a case where the operations in step S1210 and step S1220 are performed within a single SL slot when the CSI request is indicated through SCI.

In step S1220, the RX UE 902 may receive the CSI-RS from the TX UE 901 based on the schemes described above. Additionally, the RX UE 902 may receive SS or DMRS from the TX UE 901 in addition to the CSI-RS.

In step S1230, the RX UE 902 may perform a reception beam switching procedure. In other words, in step S1230, the RX UE 902 may identify an optimal reception (RX) beam by switching a reception beam for a transmission beam through which the TX UE 901 transmits the CSI-RS. In step S1230, the RX UE 902 may switching the reception beam to the optimal reception beam.

As an example of the procedure for identifying the optimal reception beam, the RX UE 902 may measure reception qualities of the same single transmission beam using multiple reception beams.

If the RX UE 902 is assumed to support a case where four reception beams are configured, the RX UE 902 may measure a reception quality of reference signal(s) (e.g. CSI-RS, SS, DMRS) included in a transmission beam transmitted by the TX UE 901 using a first reception beam (e.g. RX beam #1). The RX UE 902 may then measure a reception quality of the reference signal(s) included in the transmission beam transmitted by the TX UE 901 using a second reception beam (e.g. RX beam #2). The above-described process may be performed up to a fourth reception beam. The RX UE 902 may then select a reception beam with the best reception quality among the reception qualities measured through the first to fourth reception beams as a reception beam to be used for SL communication with the TX UE 901.

The procedure of FIG. 12 described above, compared to FIG. 9, may involve performing a reception beam switching procedure instead of a CSI reporting procedure in the final step.

Meanwhile, using the operations described with reference to Tables 3 and 4 in the first exemplary embodiment (e.g. Operational Examples #1 to #4) may be applied in the fourth exemplary embodiment in the same manner. Therefore, the fourth exemplary embodiment may also use the first-stage SCI according to the present disclosure, namely SCI format 1-B. Additionally, the fourth exemplary embodiment may also use the second-stage SCI according to the present disclosure, namely SCI format 2-D.

Since the operations of these aspects can be carried out from the same perspective as in the first exemplary embodiment, redundant descriptions are omitted.

FIG. 13 is a sequence chart illustrating a case where a transmission beam is switched based on a CSI request from a TX UE.

Each of the TX UE 901 and RX UE 902 illustrated in FIG. 13 may serve as an entity performing a procedures of FIG. 13. Additionally, as described in FIG. 9 to FIG. 11, each of them may be one of the communication nodes of FIG. 1 and may include at least part or all of the components described in FIG. 3. Furthermore, each of them may include at least part of the components described in FIG. 4 to FIG. 8.

In step S1310, the RX UE 902 may transmit a CSI request to the TX UE 901. The CSI request transmitted by the RX UE 902 may be a message or signal for triggering CSI reporting by the TX UE 901. Additionally, the CSI request transmitted by the RX UE 902 to the TX UE 901 may be indicated using first-stage SCI and/or second-stage SCI. As another example, the CSI request transmitted by the RX UE 902 to the TX UE 901 may be indicated through a MAC-CE. As yet another example, the CSI request transmitted by the RX UE 902 to the TX UE 901 may be indicated through a combination of two or more among first-stage SCI, second-stage SCI, and MAC-CE.

In step S1310, the TX UE 901 may receive the CSI request from the RX UE 902 based on one of the schemes described above.

In step S1320, the RX UE 902 may transmit a CSI-RS to the TX UE 901. The CSI-RS transmitted by the RX UE 902 may be transmitted in a (pre) defined time-frequency resource region or in a time-frequency resource region configured through the CSI request message. Additionally, in step S1320, the RX UE 902 may transmit the CSI-RS through multiple beams that the RX UE 902 can use for transmission or through a single beam, for example, a beam used for sidelink communication. If the CSI-RS is transmitted through multiple beams, the CSI-RS is transmitted through beam sweeping.

If the CSI request in step S1310 is indicated through SCI, the SCI including the CSI request may indicate configuration information of at least one of a time resource, frequency resource, transmission pattern, transmission density, or types of CSI to be reported, which are related to for CSI-RS transmission. In this case, the RX UE 902 may transmit the CSI-RS in step S1320 to the TX UE 901 based on the configured information of a SL slot including the SCI with the CSI request. Furthermore, in step S1320, the RX UE 902 may transmit other types of reference signals, such as SS or DMRS, to the TX UE 901 in the same slot as the CSI-RS transmission. Therefore, when the CSI request is indicated through SCI, the operations in step S1310 and step S1320 may be performed within a single SL slot.

As another example, even if the CSI request is indicated through SCI, CSI-RS transmission may occur in a different slot. For example, the SCI may instruct measurement and reporting of a CSI-RS transmitted in a specific slot. As a specific example, the SCI including the CSI request may be transmitted in a slot #1, and the SCI may instruct the measurement and reporting of a CSI-RS transmitted in a slot #2 or slot #3. As another specific example, the SCI including the CSI request may be transmitted in a slot #1, and the SCI may instruct the measurement and reporting of a CSI-RS transmitted in a slot after a specific number of slots from the current slot #1.

For convenience of description, the following description assumes a case where the operations in step S1310 and step S1320 are performed within a single SL slot when the CSI request is indicated through SCI.

In step S1320, the TX UE 901 may receive the CSI-RS from the RX UE 902 based on the schemes described above. Additionally, the TX UE 901 may receive SS or DMRS from the RX UE 901 in addition to the CSI-RS.

In steps S1310 and S1320, the TX UE 901 may receive the CSI request and the CSI-RS transmitted through specific beam(s) and may measure CSI.

In step S1130, the TX UE 901 may switch a beam used for transmission to the RX UE 902 and perform transmission using the switched beam. FIG. 13 may correspond to a case where beam reciprocity is established, as described earlier. Therefore, a reception beam of the TX UE 901, in other words, a beam used to receive a transmission bam from the RX UE 902, may correspond to a beam used by the TX UE 901 to perform transmission to the RX UE 902.

Accordingly, the TX UE 901 may measure qualities of a beam transmitted by the RX UE 902 while switching reception beams and may determine an optimal reception beam. The determined optimal reception beam may be used as a transmission beam when the TX UE 901 transmits SL data to the RX UE 902.

For example, if the TX UE 901 is assumed to have four beams that can be used as transmission beams (or reception beams), the TX UE 901 may measure a reception quality of reference signal(s) (e.g. CSI-RS, SS, DMRS) included in a transmission beam transmitted by the RX UE 902 using a first reception beam (e.g. RX beam #1). The TX UE 901 may then measure a reception quality of the reference signal(s) included in the transmission beam transmitted by the RX UE 902 using a second reception beam (e.g. RX beam #2). The above-described process may be performed up to a fourth reception beam. The TX UE 901 may then select a reception beam with the best reception quality among the reception qualities measured through the first to fourth reception beams as a reception beam to be used for SL communication with the RX UE 902.

The beam determined by the TX UE 901 in the above-described manner may be used as a transmission beam for the TX UE 901 to transmit SL data to the RX UE 902. Therefore, step S1330 in FIG. 13 may correspond to a transmission beam switching operation.

The procedure of FIG. 13 described above, compared to FIG. 11, may involve performing a reception beam switching procedure instead of performing a CSI reporting procedure to the TX UE 901 in the final step.

Meanwhile, using the operations described with reference to Tables 3 and 4 in the first exemplary embodiment (e.g. Operational Examples #1 to #4) may be applied in the fourth exemplary embodiment in the same manner. Therefore, the fourth exemplary embodiment may also use the first-stage SCI according to the present disclosure, namely SCI format 1-B. Additionally, the fourth exemplary embodiment may also use the second-stage SCI according to the present disclosure, namely SCI format 2-D.

Since the operations of these aspects can be carried out from the same perspective as in the first exemplary embodiment, redundant descriptions are omitted.

On the other hand, there may be a case where both the transmission beam and reception beam between the TX UE 901 and RX UE 902 need to be switched. In this case, one of the procedures in FIG. 12 or FIG. 13 may be performed first, followed by the other procedure, to switch both the transmission beam and reception beam.

As another example, when both the transmission beam and reception beam between the TX UE 901 and RX UE 902 need to be switched, a priority may be given to one procedure to be performed first. For instance, based on the most recent measurement information of the currently used transmission or reception beam, a priority may be given to switching of a beam whose update period has exceeded a certain threshold.

As another example, when both the transmission beam and reception beam between the TX UE 901 and RX UE 902 need to be switched, a priority may be given to switching of a beam with the longest elapsed update time among the transmission beam and reception beam.

On the other hand, the above description pertains to a case where beam reciprocity is established. In contrast, in an environment without beam reciprocity, a scheme in which the TX UE 901 transmits a CSI-RS during transmission beam switching may be applied. For instance, the transmission beam may be switching using the scheme described in FIG. 9 or FIG. 10.

For example, in step S920 of the method in FIG. 9, the TX UE 901 may transmit the CSI-RS through multiple beams. Alternatively, in step S1020 of the scheme in FIG. 10, the TX UE 901 may transmit the CSI-RS through multiple beams. The RX UE 902 may then measure CSI for each of the multiple beams and select a beam with the best reception signal quality. Accordingly, in step S930 or S1030, the RX UE 902 may perform CSI reporting by including a transmission beam index with the best reception quality in a CSI report. As another example of CSI reporting in step S930 or S1030, the RX UE 902 may report a transmission beam index and a reception quality for each beam to the TX UE 901.

On the other hand, during reception beam switching in an environment without beam reciprocity, the method in which the TX UE 901 transmits the CSI-RS in the same manner as described may be applied. For instance, the reception beam may be switched using the scheme described in FIG. 9 or FIG. 10.

For example, in step S920 of FIG. 9 or step S1020 of FIG. 10, the TX UE 901 may transmit the CSI-RS through a single beam. The RX UE 902 may then measure CSI for the single transmission beam through which the CSI-RS is transmitted by using multiple reception beams. The RX UE 902 may select a reception beam with the highest CSI measurement value for the single transmission beam among the multiple reception beams. Accordingly, the RX UE 902 may switch the reception beam instead of reporting CSI in step S930 or S1030.

In the above description on switching of the transmission or reception beam, cases where the CSI-RS is used have been provided as examples. However, beam information measurement may also utilize other reference signals, such as SS or DMRS of PSSCH, in addition to the CSI-RS.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first user equipment (UE), comprising:
transmitting, to a second UE, a channel state information (CSI) request requesting to report CSI for transmission beam(s);
transmitting a pre-configured signal to the second UE through the transmission beam(s); and
receiving, from the second UE, a CSI report for the transmission beam(s),
wherein the CSI request includes information on a type of the pre-configured signal for beam management, and the information on the type of the pre-configured signal indicates at least one of a CSI-reference signal (CSI-RS), a synchronization signal (SS), or a demodulation reference signal (DMRS).

2. The method according to claim 1, wherein when the CSI request indicates the CSI-RS and the DMRS together, and the pre-configured signal is transmitted through two or more transmission beams, the CSI report is measurement information using the DMRS for a first transmission beam being used for sidelink communication.

3. The method according to claim 2, wherein the DMRS is transmitted through the first transmission beam, and the CSI-RS is transmitted through all of the two or more transmission beams.

4. The method according to claim 1, wherein when the CSI request indicates the SS and the CSI-RS together, and the pre-configured signal is transmitted through two or more transmission beams, the CSI report is measurement information using the SS for a first transmission beam being used for sidelink communication.

5. The method according to claim 4, wherein the SS is transmitted through the first transmission beam, and the CSI-RS is transmitted on all of the two or more transmission beams.

6. The method according to claim 1, wherein the CSI request is transmitted by first-stage sidelink control information (SCI), and the first-stage SCI includes at least one of information indicating absence of second-stage SCI, resource configuration information of the pre-configured signal, information indicating the CSI request, information on a CSI reporting type, information on a number of CSI reports, resource information for a container to be used for CSI reporting, information on a latency bound for CSI reporting, or timing information for CSI reporting.

7. The method according to claim 6, wherein the information on the CSI reporting type indicates at least one of a Reference Signal Received Power (RSRP) for a beam, beam quality information (BQI) indicating a Layer 1-RSRP (L1-RSRP), a beam index (BI) indicating CSI for management purposes, channel quality information (CQI), or rank indicator (RI).

8. A method of a second user equipment (UE), comprising:
receiving, from a first UE, a channel state information CSI request requesting to report CSI for transmission beam(s) of the first UE;
receiving a pre-configured signal through the transmission beam(s) of the first UE based on the CSI request;
measuring the received pre-configured signal to generate a CSI report for the transmission beam(s); and
transmitting the CSI report to the first UE,
wherein the CSI request includes information on a type of the pre-configured signal for beam management, and the information on the type of the pre-configured signal indicates at least one of a CSI-reference signal (CSI-RS), a synchronization signal (SS), or a demodulation reference signal (DMRS).

9. The method according to claim 8, wherein when the CSI request indicates the CSI-RS and the DMRS together, and the pre-configured signal is transmitted through two or more transmission beams, the CSI report is generated based on measurement of the DMRS received through a first transmission beam being used for sidelink communication.

10. The method according to claim 9, further comprising: performing refinement on the transmission beam(s) by using the CSI-RS included in a transmission beam other than the first transmission beam.

11. The method according to claim 8, wherein when the CSI request indicates the SS and the CSI-RS together, and the pre-configured signal is transmitted through two or more transmission beams, the CSI report is generated based on measurement of the SS received through a first transmission beam being used for sidelink communication.

12. The method according to claim 11, further comprising: performing refinement on the transmission beam(s) by using the CSI-RS included in a transmission beam other than the first transmission beam.

13. The method according to claim 8, wherein the CSI request is transmitted by first-stage sidelink control information, and the first-stage SCI includes at least one of information indicating absence of second-stage SCI, resource configuration information of the pre-configured signal, information indicating the CSI request, information on a CSI reporting type, information on a number of CSI reports, resource information for a container to be used for CSI reporting, information on a latency bound for CSI reporting, or timing information for CSI reporting.

14. The method according to claim 13, wherein the information on the CSI reporting type indicates at least one of a Reference Signal Received Power (RSRP) for a beam, beam quality information (BQI) indicating a Layer 1-RSRP (L1-RSRP), a beam index (BI) indicating CSI for management purposes, channel quality information (CQI), or rank indicator (RI).

15. A first user equipment (UE) comprising at least one processor, wherein the at least one processor causes the first UE to perform:
transmitting, to a second UE, a channel state information (CSI) request requesting to report CSI for transmission beam(s);
transmitting a pre-configured signal to the second UE through the transmission beam(s); and
receiving, from the second UE, a CSI report for the transmission beam(s),
wherein the CSI request includes information on a type of the pre-configured signal for beam management, and the information on the type of the pre-configured signal indicates at least one of a CSI-reference signal (CSI-RS), a synchronization signal (SS), or a demodulation reference signal (DMRS).

16. The first UE according to claim 15, wherein when the CSI request indicates the CSI-RS and the DMRS together, and the pre-configured signal is transmitted through two or more transmission beams, the CSI report is measurement information using the DMRS for a first transmission beam being used for sidelink communication.

17. The first UE according to claim 16, wherein the DMRS is transmitted through the first transmission beam, and the CSI-RS is transmitted through all of the two or more transmission beams.

18. The first UE according to claim 15, wherein when the CSI request indicates the SS and the CSI-RS together, and the pre-configured signal is transmitted through two or more transmission beams, the CSI report is measurement information using the SS for a first transmission beam being used for sidelink communication.

19. The first UE according to claim 18, wherein the SS is transmitted through the first transmission beam, and the CSI-RS is transmitted on all of the two or more transmission beams.

20. The first UE according to claim 15, wherein the CSI request is transmitted by first-stage sidelink control information (SCI), and the first-stage SCI includes at least one of information indicating absence of second-stage SCI, resource configuration information of the pre-configured signal, information indicating the CSI request, information on a CSI reporting type, information on a number of CSI reports, resource information for a container to be used for CSI reporting, information on a latency bound for CSI reporting, or timing information for CSI reporting.
